(19) United States
(12) Patent Application Publication
(10) Pub. No.: US 2026/0257407 A1
(43) Pub. Date: Sep. 3, 2026

(54) THIXOTROPIC INJECTION MOLDING BARREL ASSEMBLY

(71) Applicant: Leggera Thixo Technologies LLC, Orion Township, MI (US)

(72) Inventors: Thomas Darnell, Orion Township, MI (US); Nathan Sanko, Orion Township, MI (US)

(21) Appl. No.: 19/068,870

(22) Filed: Mar. 3, 2025

(51) Int. Cl. B29C 45/62; B29C 45/60; B29C 45/74

(52) U.S. Cl. CPC B29C 45/62; B29C 45/60; B29C 45/74

(57) ABSTRACT

A thixotropic injection molding barrel assembly broadly comprising a loader, a barrel, a screw, and a nozzle. The loader includes an opening for receiving magnesium chips. The barrel includes a first section configured to be connected to the loader and a second section configured to be removably connected to the first section opposite the loader. The loader, the first section, and the second section form a screw chamber. The screw is positioned in the screw chamber and includes a rotatable shaft, a helical screw flight, and a check ring positioned near a distal end of the screw. The nozzle is positioned near a distal end of the screw chamber. The second section forms an injection chamber portion of the screw chamber when the shaft is in a retracted position.

### BACKGROUND

Conventional thixotropic injection molding utilizes a barrel assembly including a barrel forming a screw chamber in which magnesium chips are heated to a high temperature and sheared to create a thixotropic slurry. The slurry is then forced at high pressure from an injection chamber portion of the screw chamber through a nozzle at a distal end of the barrel into a mold in an injection phase. The high temperature and pressure cause several issues.

The assembly is prone to leakage between a face of the barrel and a face of the endcap during the injection phase and during “plug blow” immediately preceding the injection phase. Specifically, the extreme cyclic forces of injection at high temperature repeatedly stress endcap bolts and corresponding barrel threads. This results in excessive downtime, costly repairs, excessive scrap due to restarts, and fire and safety risks due to molten magnesium leakage.

The endcap also creates a heat barrier between the face of the barrel and the face of the endcap. To overcome this, a small endcap heater heats the endcap, but the endcap heater must operate at a high duty to sustain the slurry in melted form. The lack of heat transfer from larger heaters surrounding the barrel to the endcap due to the heat barrier slows the production of slurry during a recovery stage, which increases overall cycle time. This also results in less temperature control in the injection chamber and hence a narrow operating window for achieving desired conditions. Furthermore, the small endcap heater has a small lifespan, thus resulting in significant service downtime and increased maintenance costs.

The barrel is formed of expensive high temperature, forged material. Unfortunately, the barrel forms a high wear zone near the injection chamber in which a check ring wears against a wall of the barrel. Due to the high temperature and pressure, the barrel wears out quickly, resulting in a short service life. The barrel is also non-repairable. After the check ring sufficiently wears the barrel at the high wear zone, the check ring is eventually removed and increased in size to maintain critical tolerances. Eventually, the barrel wears enough to no longer be usable. This adds significant costs.

The barrel assembly is also difficult to service. Specifically, the entire barrel must be removed to service or replace check ring wear components. This requires the barrel assembly to be cooled down from approximately 600 degrees Celsius to approximately 120 degrees Celsius before the barrel is removed. The cooldown may take up to eight hours before another replacement barrel assembly can be installed, resulting in up to sixteen hours of service time. With the check ring having a service life of approximately 60,000 injections, barrel maintenance results in significant downtime and additional costs.

### SUMMARY OF THE INVENTION

Embodiments of the present invention solve the above-mentioned problems and provide a distinct advance in the art of thixotropic injection molding barrel assemblies. More particularly, the present invention provides a thixotropic injection molding barrel assembly that eliminates leakage and improves temperature control by integrating an endcap with the barrel. The barrel assembly also includes a two-part barrel that isolates a high wear zone for reduced replacement costs and simplified maintenance.

An embodiment of the present invention is a thixotropic injection molding barrel assembly broadly comprising a loader, a barrel, a screw, and a nozzle. The loader includes an opening for receiving magnesium chips. The barrel includes a first section configured to be connected to the loader and a second section configured to be removably connected to the first section opposite the loader. The loader, the first section, and the second section form a screw chamber. The screw is positioned in the screw chamber and includes a rotatable shaft, a helical screw flight, and a check ring positioned near a distal end of the screw. The nozzle is positioned near a distal end of the screw chamber. The second section forms an injection chamber portion of the screw chamber when the shaft is in a retracted position.

Another embodiment is a method of thixotropic injection molding comprising a step of inserting magnesium chips into a first section of a screw chamber of a barrel of a thixotropic injection molding barrel assembly via a loader. The barrel includes a first section and a second section removably connected to the first section. The method further comprises a step of rotating a screw in the screw chamber and heating the barrel thereby compressing and shearing the magnesium chips so the magnesium chips melt into a thixotropic slurry. The method further comprises a step of shifting the screw to a retracted position such that some of the thixotropic slurry is forced past a check ring on the screw and enters an injection chamber portion of the screw chamber in the second section. The method further comprises a step of shifting the screw to a forward stroke position such that the thixotropic slurry is injected into a mold from the injection chamber portion.

Another embodiment is a thixotropic injection molding barrel assembly broadly comprising a loader, a barrel, a screw, a nozzle, a nozzle cap, a first heating element, and a second heating element. The loader includes an opening for receiving magnesium chips. The barrel includes a first section configured to be connected to the loader and a second section configured to be removably connected to the first section opposite the loader. The second section includes an integrated end cap. The loader, the first section, and the second section form a screw chamber. The screw is positioned in the screw chamber and includes a rotatable shaft, a helical screw flight on the rotatable shaft, a tip removably connectable to the rotatable shaft, and a check ring positioned on the tip. The nozzle is connected to the second section. The nozzle cap retains the nozzle on the integrated end cap. The first heating element encircles and is configured to heat the first section. The second heating element encircles and is configured to heat the second section. The second section forms an injection chamber portion of the screw chamber when the shaft is in a retracted position.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a thixotropic injection molding barrel assembly constructed in accordance with an embodiment of the invention;

FIG. 2 is another perspective view of the thixotropic injection molding barrel assembly of FIG. 1;

FIG. 3 is a side elevation view of the thixotropic injection molding barrel assembly of FIG. 1;

FIG. 4 is a cutaway side elevation view of the thixotropic injection molding barrel assembly of FIG. 1;

FIG. 5 is a cutaway side elevation view of the thixotropic injection molding barrel assembly of FIG. 1; and

FIG. 6 is a flow diagram depicting certain steps of a method of thixotropic injection molding in accordance with another embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION

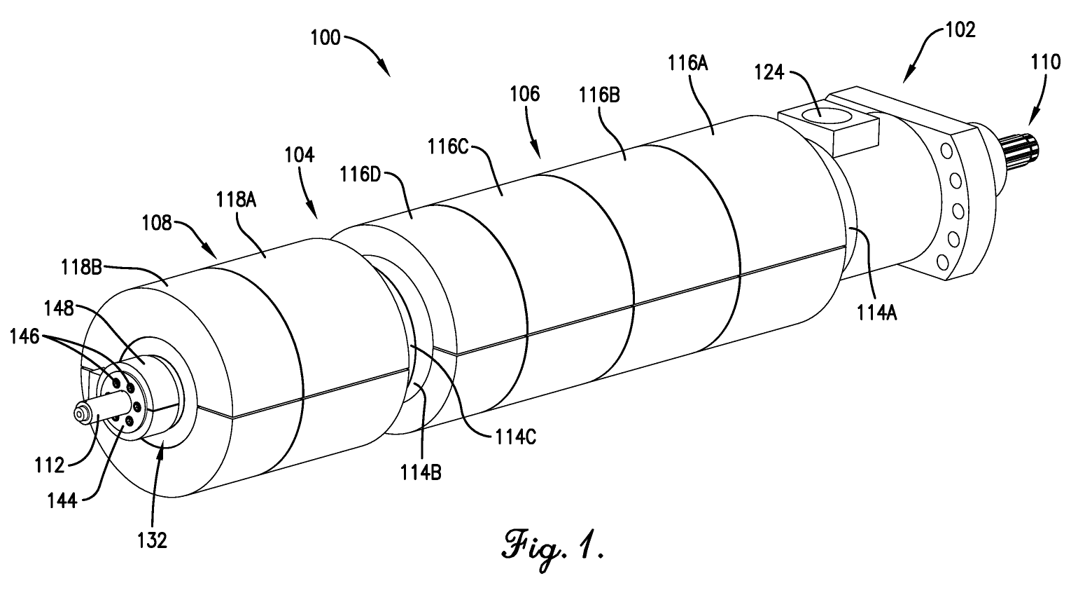

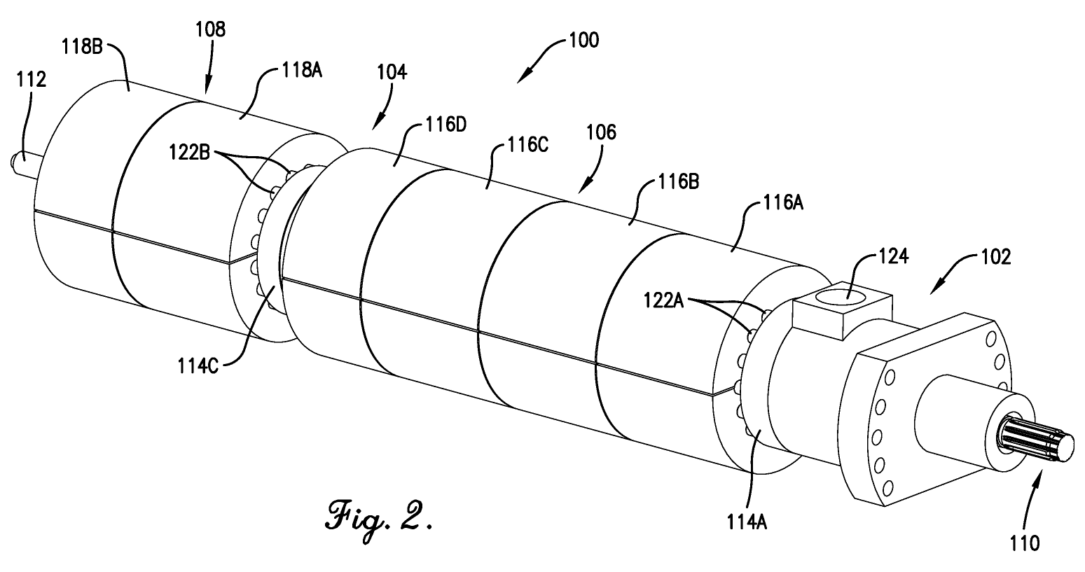

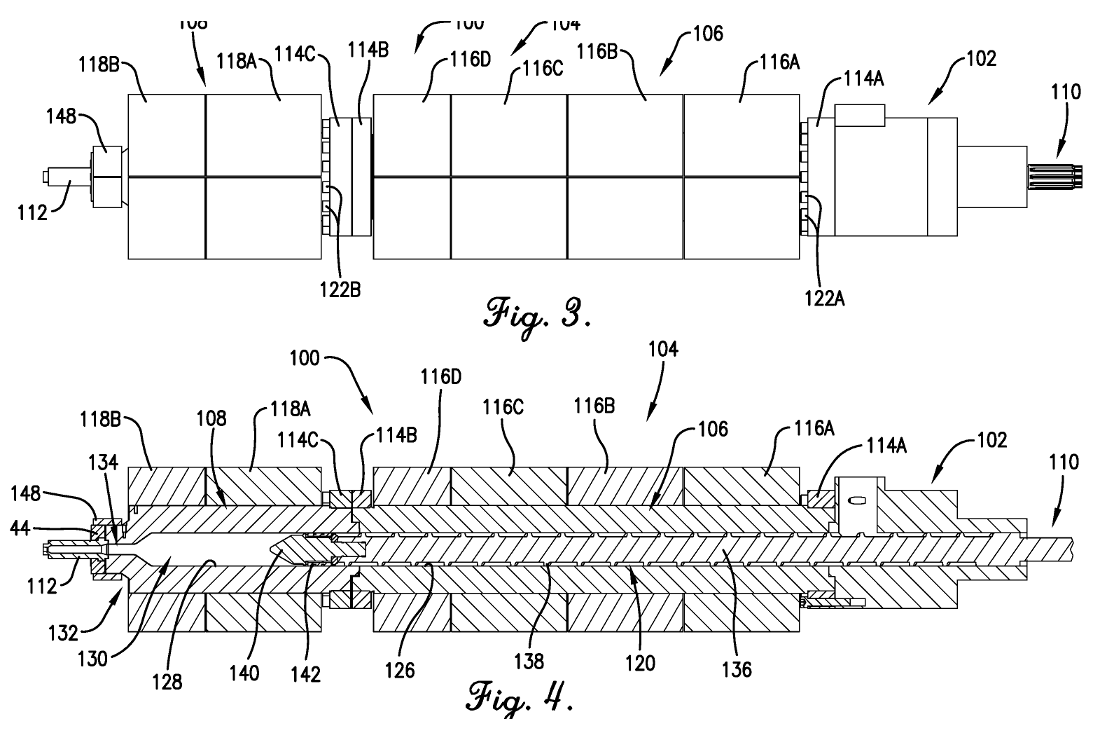

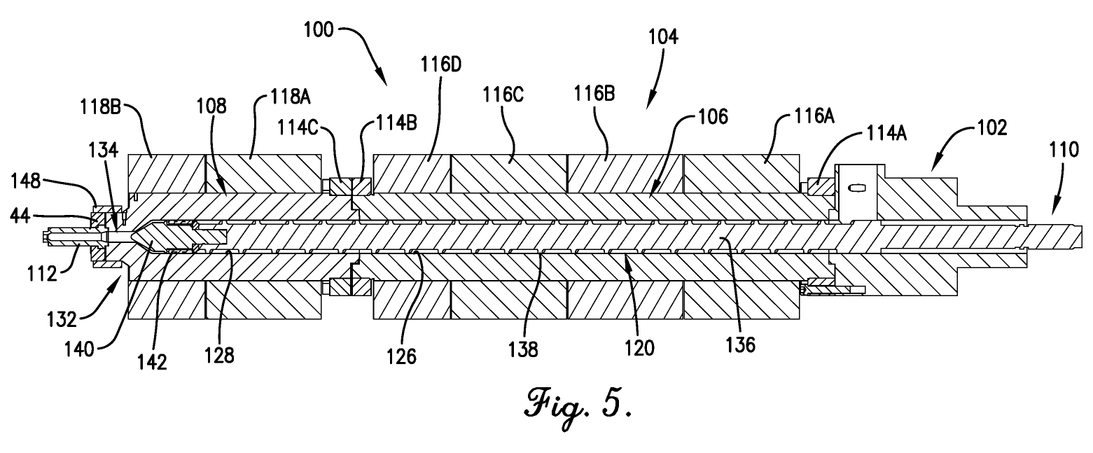

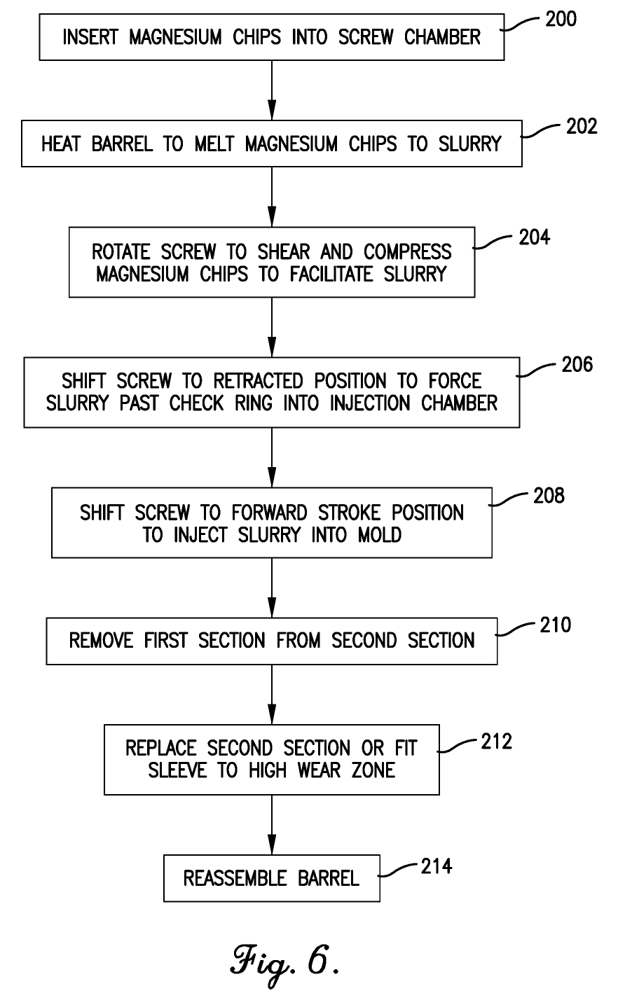

Turning to FIG. 1, a thixotropic injection molding barrel assembly 100 (hereinafter “assembly 100”) constructed in accordance with an embodiment of the invention will now be described. The barrel assembly 100 broadly comprises a loader 102, a barrel 104 having first and second sections 106, 108, a screw 110, a nozzle 112, a plurality of connecting flanges 114A-C, and first and second sets of heating elements 116A-D, 118A,B. The loader 102 and the first and second sections 106, 108 of the barrel 104 may form a screw chamber 120.

The loader 102 may be configured to be removably connected to a hopper, and to a first end of the first section 106 of the barrel 104 via the connecting flange 114A and fasteners 122A. The loader 102 may include an opening 124 intersecting with the screw chamber 120 for receiving magnesium chips from the hopper. The opening 124 may be positioned on a top of the loader 102 for gravity feeding the magnesium chips into the screw chamber 120.

The barrel 104 may be a two-part or two-piece barrel including the aforementioned first section 106 and second section 108. The barrel 104 may be positioned between the loader 102 and a mold. The barrel 104 may be formed of expensive high temperature, forged material such as DIN 1.2888 steel.

The first section 106 may be configured to be removably connected to the loader 102 via the connecting flange 114A and to the second section 108 via the connecting flanges 114B,C and fasteners 122B. The first section 106 may form a low wear zone 126 along the portion of the screw chamber 120 in the first section 106. As such, the first section 106 may only need to be replaced or repaired infrequently.

The second section 108 may be configured to be removably connected to the first section 106 via the connecting flanges 114B,C and fasteners 122B. The second section 108 may form a high wear zone 128 along a portion of the screw chamber 120 in the second section 108. The high wear zone 128 may at least partially coincide with an injection chamber 130 as described in more detail below. Due to the high wear zone 128, the second section 108 may need to be replaced or repaired more frequently than the first section.

The second section 108 may include an integrated endcap 132 having a small injection channel 134. At least a portion of the integrated endcap 132 may have a diameter smaller than a diameter of a main portion of the second section 108. Importantly, the integrated endcap 132 is a monolithic portion of the second section 108 so that the integrated endcap 132 can more effectively absorb forces from an injection stroke. Furthermore, the integrated endcap 132 distributes heat around the end of the second section 108 unimpeded due to the absence of heat barriers. The injection channel 134 fluidly connects the screw chamber 120 with a channel of the nozzle 112.

The screw 110 may be positioned in the screw chamber 120 and may include a shaft 136, a screw flight 138, a tip 140, and a check ring 142. The screw 110 may be configured to rotate about a longitudinal axis and shift longitudinally in the screw chamber 120 between a retracted position and a forward stroke position.

At least a portion of the shaft 136 may extend out an end of the loader 102 and attached to an actuator for rotating and shifting the shaft 136. The shaft 136 may have a smaller diameter than a diameter of the screw chamber 120 to allow magnesium chips to occupy a space between the shaft 136 and the barrel 104.

The screw flight 138 may be a helical auger thread encircling the shaft 136. The screw flight 138 may be configured to shear and compress to facilitate melting the magnesium chips into a slurry. The screw flight 138 may also be configured to urge the slurry toward and past the check ring 142 via rotation and longitudinal shifting of the screw 110.

The tip 140 may be removably connected to a distal end of the shaft 136 and may have a tapered or conical shape for nesting in the injection channel 134 of the integrated endcap 132 of the second section 108. The tip 140 may also be configured to retain the check ring 142 there.

The check ring 142 may be a one-way valve that encircles the tip 140 or the shaft 136 and may include features, geometry, or material properties for allowing slurry to pass between the check ring 142 and the second section 108 in a first direction while preventing slurry from passing the check ring 142 in the second section. The check ring 142 may have a tight tolerance with the second section 108 at least during the injection stroke, thus resulting in the high wear zone 128.

The nozzle 112 may be positioned near the integrated endcap 132 and may form an extension of the injection channel 134 of the integrated endcap 132. The nozzle 112 may be retained against the integrated endcap 132 via a nozzle cap 110 and fasteners 146. A diameter of the nozzle cap 110 may be substantially similar to a diameter of a portion of the integrated endcap 132. A heating ring 142 may encircle at least a portion of the nozzle 112 and at least a portion of the integrated endcap 132 for heating the integrated endcap 132 and the nozzle 112.

The connecting flanges 114A-C may be configured to removably connect certain components of the barrel assembly 100 via fasteners 122A,B. For example, the connecting flange 114A may encircle one end of the first section 106 of the barrel 104 against the loader 102 and secured thereto with fasteners 122A. The connecting flange 114B may encircle an opposing end of the first section 106 and the connecting flange 114C may encircle one end of the second section 108 so the connecting flanges 114B,C may abut each other and be secured together via fasteners 122B, thus retaining the first section 106 and the second section 108 together. The connecting flanges 114A-C may be threaded for engaging corresponding threads on the first section 106 and the second section 108. The connecting flanges 114A-C may be formed of a different material than a material of the first and second sections 106, 108. Specifically, the material of the connecting flanges 114A-C may be less expensive or more readily available than the material of the barrel 104. The material may not have the heat handling characteristics of the material of the first or second sections 106, 108.

The first set of heating elements 116A-D may encircle the first section 106 and may be configured to heat the first section 106 and hence magnesium chips in the screw chamber 120 for melting them into a slurry. The first set of heating elements 116A-D may be configured to heat the first section 106 to a temperature lower than a temperature to which the second section 108 is heated by the second set of heating elements 118A,B.

The second set of heating elements 118A,B may encircle the second section 108 and may be configured to heat the second section 108 and hence the slurry in the screw chamber 120. The second set of heating elements 118A,B may further heat the slurry in the injection chamber 130 (i.e., after the screw 110 has been shifted to the retracted position and the slurry has passed the check ring 142). The second set of heating elements 118A,B may be configured to heat the second section 108 to a temperature higher than a temperature to which the first section 106 is heated by the first set of heating elements 116A-D. In one embodiment, the second set of heating elements 118A,B may heat the second section 108 to a temperature of approximately 600 degrees Celsius.

Use of the barrel assembly 100 will now be described. First, magnesium chips may be urged or allowed to enter the screw chamber 120 through the opening 124 of the loader 102, as shown in block 200. Argon or a similar gas may also be injected into the magnesium chips to prevent oxidation from ambient air.

The heating elements 116A-D, 118A,B may also heat the first and second sections 106, 108 of the barrel 104 thereby melting the magnesium chips into a magnesium alloy slurry, as shown in block 202. Temperatures in the first section 106 and the second section 108, or the low wear zone 126 and the high wear zone 128 (or any other portions of the invention) may be precisely controlled and regulated, thus forming several regulated temperature zones. To that end, the second set of heating elements 118A,B may heat the second section 108 and hence the slurry to approximately 600 degrees Celsius. In one embodiment, the first set of heating elements 118A-D may heat the first section 106 to a temperature below approximately 600 degrees Celsius so that high temperatures and pressures are limited to the second section 108.

The screw 110 may be rotated so the screw flight 138 shears and compresses the magnesium chips thereby facilitating their conversion to the slurry, as shown in block 204. The progressively melted and agitated slurry may be brought to a thixotropic state comprised of a controlled percentage of solids and liquid melt dictated by temperature.

The thixotropic slurry may then be forced past the check ring 142 and hence into the injection chamber 130 via pressure induced from shifting the screw 110 to the retracted position, as shown in block 206. The injection chamber 130 is a portion of the screw chamber 120 bounded by the check ring 142 and the injection channel 134. The injection chamber 130 increases in size by the screw 110 being shifted to the retracted position. A seal may be created in the injection channel 134 in the nozzle 112 as the slurry hardens into a plug from exposure to ambient air temperatures. The plug blocks the nozzle 112 thus allowing the injection chamber 130 to be filled to a precise volume of thixotropic slurry. The screw 110 may stop rotating and retracting when a desired slurry volume is achieved in the injection chamber 130. This may be called a recovery stage or material conditioning time.

The slurry may then be injected into the mold from the injection chamber 130 by a rapid forward stroke of the screw 110 toward the nozzle to a forward stroke position via a high-speed hydraulic injection unit, as shown in block 208. This may be called an injection stage. During the injection stage, the plug may be blown out of the nozzle 112 and the slurry in the injection chamber (i.e., a “shot volume”) may be transferred into a cavity of the mold. The distance the screw moves forward in the injection stage may be called the “stroke”. The injection stage may occur very quickly, such as in approximately 0.013 to approximately 0.040 seconds. This results in high forces and pressure on the integrated endcap 132 and the check ring 142. The check ring 142 expands radially outward to seal against the wall of the second section 108 of the barrel 104, thus preventing backflow during the injection stage. This results in the high wear zone 128 on the wall of the second section 108. The injection stage also occurs at an extremely high temperature such as approximately 600 degrees Celsius.

The injection stage may be followed by a recovery stage in which the screw 110 is shifted back to the retracted position. The above steps may then be repeated for subsequent injections.

The second section 108 may need to be replaced once enough wear occurs at the high wear zone 128. To that end, the second section 108 may be removed from the first section 106 by unsecuring flanges 114B,C from each other or unsecuring one of the flanges 114B,C from one of the first section 106 and second section 108, as shown in block 210. This minimizes the number of parts that have to be removed, disconnected, or disassembled and minimizes the amount of expensive material that has to be discarded. For example, the first section 106 does not need to be disconnected from the loader 102 during replacement of the second section 108. The second section 108 may then be replaced with a replacement second section, as shown in block 212. Alternatively, because the second section 108 includes the integrated endcap 132 and thus does not have a leak path in the high pressure injection chamber 130, the second section 108 may be fitted with a sleeve in the high wear zone 128 to re-establish desired tolerances. The barrel 104 may then be reassembled (with a refitted second section 108 or a replacement second section), as shown in block 214.

The above-described invention provides several advantages. For example, the integrated endcap 132 eliminates endcap leakage since the integrated endcap 132 is monolithic with the rest of the second section 108. The second section 108, along with the integrated endcap 132, is connected to the first section 106 away from the high temperature and high pressure injection chamber 130. The flanges 114B,C and fasteners 122B thus are not subjected to high temperatures and pressure. This prevents threads of the flanges 114B,C, corresponding threads of the first section 106 and second section 108, and threads of the fasteners 122B from stretching, creeping, and loosening.

The integrated endcap 132 also eliminates the need for small heaters and eliminates a thermal barrier. Instead, the integrated endcap 132 allows for full-size heaters (second set of heating elements 118A,B) with sufficient wattage to unimpededly (i.e., without a thermal barrier) heat the injection chamber 130. As such, the temperature in the injection chamber 130 can be controlled rapidly and precisely. This temperature control may reduce recovery time and cycle time by approximately ten seconds.

The high wear zone 128 is located entirely in the second section 108 such that only the second section 108 needs to be removed and replaced when the high wear zone 128 degrades sufficiently to warrant maintenance. This significantly reduces the amount of material being discarded compared to an entire barrel being replaced. The first section 106, having only the low wear zone 126, may exhibit very little wear due to the relatively low pressures and temperatures therein and thus rarely needs to be replaced. Similarly, to service or replace the check ring 142, the tip 140, gaskets, and other wear components, the second section 108 can be removed to access these components without removing the first section 106. This further reduces downtime and related expenses.

The flanges 114A-C and their threads may be made of low cost or common material, while the first section 106 and second section 108 of the barrel 104 may be made of more expensive high temperature, forged material such as DIN 1.2888 steel. Connecting the loader 102, the first section 106, the second section 108 together via such flanges 114A-C reduces the necessary diameter of the first section 106 and the second section 108 of the barrel 104, thus reducing the cost of production of the barrel assembly 100.

Furthermore, maintenance, repair, or replacement of parts only requires removal of the second section 108. This reduces the amount of time needed to wait for the barrel assembly 100 to cool down, which reduces service time and associated expenses.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises”, “comprising”, “includes”, “including”, “has”, “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A thixotropic injection molding barrel assembly comprising:
a loader including an opening for receiving magnesium chips;
a barrel including:
a first section configured to be connected to the loader; and
a second section configured to be removably connected to the first section opposite the loader, wherein the loader, the first section, and the second section form a screw chamber;
a screw positioned in the screw chamber and including:
a rotatable shaft;
a helical screw flight; and
a check ring positioned near a distal end of the screw; and
a nozzle positioned near a distal end of the screw chamber,
wherein the second section forms an injection chamber portion of the screw chamber when the shaft is in a retracted position.

2. The thixotropic injection molding barrel assembly of claim 1, wherein the second section forms an integrated end cap configured to withstand longitudinal stresses.

3. The thixotropic injection molding barrel assembly of claim 2, further comprising a nozzle cap configured to retain the nozzle on the integrated end cap, wherein the nozzle cap has a smaller outer diameter than an outer diameter of the second section.

4. The thixotropic injection molding barrel assembly of claim 3, further comprising a ring encircling at least a portion of the nozzle cap and at least a portion of the integrated end cap.

5. The thixotropic injection molding barrel assembly of claim 1, wherein the first section forms a low wear zone and the second section forms a high wear zone.

6. The thixotropic injection molding barrel assembly of claim 5, further comprising a threaded connecting flange positioned on the first section and a threaded connecting flange positioned on the second section, wherein the threaded connecting flanges are configured to be bolted together.

7. The thixotropic injection molding barrel assembly of claim 6, wherein the connecting flanges are formed of a different material than the first section and the second section.

8. The thixotropic injection molding barrel assembly of claim 1, further comprising:
a first heating element encircling the first section of the barrel; and
a second heating element encircling the second section of the barrel.

9. The thixotropic injection molding barrel assembly of claim 1, wherein the second section has a shorter longitudinal length than a longitudinal length of the first section.

10. The thixotropic injection molding barrel assembly of claim 1, wherein the screw further includes a tip removably connectable to the shaft and the check ring encircles the tip.

11. A method of thixotropic injection molding, the method comprising steps of:
inserting magnesium chips into a screw chamber of a barrel of a thixotropic injection molding barrel assembly via a loader, the barrel having a first section and a second section removably connected to the first section;
rotating a screw in the screw chamber and heating the barrel thereby compressing and shearing the magnesium chips so the magnesium chips melt into a thixotropic slurry;
shifting the screw to a retracted position such that some of the thixotropic slurry is forced past a check ring on the screw and enters an injection chamber portion of the screw chamber in the second section; and
shifting the screw to a forward stroke position such that the thixotropic slurry is injected into a mold from the injection chamber portion.

12. The method of claim 11, further comprising a step of removing the second section from the first section while retaining the first section connected to the loader.

13. The method of claim 12, wherein the step of removing the second section includes unbolting the second section from the first section.

14. The method of claim 13, further comprising a step of replacing the second section with a replacement second section.

15. The method of claim 11, wherein the step of heating the barrel includes heating the first section via a first heating element and heating the second section via a second heating element.

16. The method of claim 15, wherein the second heating element has a similar heat output capacity as a heat output capacity of the first heating element.

17. The method of claim 11, wherein the second section has a shorter longitudinal length than a longitudinal length of the first section.

18. The method of claim 11, wherein the second section includes an integrated end cap.

19. The method of claim 18, wherein the step of shifting the screw to the forward stroke position includes injecting the thixotropic slurry through a nozzle retained on the integrated end cap via nozzle cap, wherein the nozzle cap has a diameter small than a diameter of the second section.

20. A thixotropic injection molding barrel assembly comprising:
a loader including an opening for receiving magnesium chips;
a barrel including:
a first section configured to be removably connected to the loader; and
a second section configured to be removably connected to the first section opposite the loader and including an integrated end cap, wherein the loader, the first section, and the second section form a screw chamber;
a screw positioned in the screw chamber and including:
a rotatable shaft;
a helical screw flight on the rotatable shaft;
a tip removably connectable to the rotatable shaft; and
a check ring positioned on the tip;
a nozzle connected to the second section;
a nozzle cap retaining the nozzle on the integrated end cap;
a first heating element encircling the first section and configured to heat the first section; and
a second heating element encircling the second section and configured to heat the second section,
wherein the second section forms an injection chamber portion of the screw chamber when the shaft is in a retracted position.
